(19) United States
(12) Patent Application Publication
(10) Pub. No.: US 2024/0214998 A1
(43) Pub. Date: Jun. 27, 2024

(54) MULTI-SLOT SIDELINK SLOT FORMAT AND SCHEDULING

(71) Applicant: QUALCOMM Incorporated, San Diego, CA (US)

(72) Inventors: Ahmed Elshafie, San Diego, CA (US); Seyedkianoush Hosseini, San Diego, CA (US); Huilin Xu, Temecula, CA (US)

(21) Appl. No.: 18/069,947

(22) Filed: Dec. 21, 2022

(51) Int. Cl. H04W 72/0446; H04W 72/25; H04W 72/40

(52) U.S. Cl. CPC H04W 72/0446; H04W 72/25; H04W 72/40

(57) ABSTRACT

Methods, systems, and devices for wireless communications are described. A user equipment (UE) may receive an indication of a resource pool. The UE may receive an indication of a sidelink communication configuration associated with a pattern of time resources of the resource pool, the pattern of time resources spanning multiple slots. The UE may transmit one or more sidelink messages to a second UE in accordance with the pattern of time resources. Alternatively or additionally, the UE may perform a sensing operation to determine available resources. The UE may transmit sidelink control information indicating a pattern of time resources spanning multiple slots. The UE may transmit one or more sidelink messages to a second UE in accordance with the pattern of time resources.

### TECHNICAL FIELD

The following relates to wireless communications, including multi-slot sidelink slot format and scheduling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may operate in sidelink communications. However, such approaches may be improved.

### SUMMARY

The described techniques relate to improved methods, systems, devices, and apparatuses that support multi-slot sidelink slot format and scheduling. A user equipment (UE) may receive an indication of a resource pool. The UE may receive an indication of a sidelink communication configuration associated with a pattern of time resources of the resource pool, the pattern of time resources spanning multiple slots. The UE may transmit one or more sidelink messages to a second UE in accordance with the pattern of time resources. Alternatively or additionally, the UE may perform a sensing operation to determine available resources. The UE may transmit sidelink control information indicating a pattern of time resources spanning multiple slots. The UE may transmit one or more sidelink messages to a second UE in accordance with the pattern of time resources.

A method is described. The method may include receiving an indication of a resource pool of resources available for sidelink communication with the first user equipment (UE), receiving, from a network entity, an indication of a sidelink communication configuration that is associated with a pattern of time resources of the resource pool in which the first UE is to transmit sidelink signaling, the pattern of time resources spanning multiple slots, and transmitting one or more sidelink messages to a second UE in accordance with the pattern of time resources.

A first UE is described. The first UE may include one or more processors, memory coupled with the one or more processors, and instructions stored in the memory. The instructions may be executable by the processor to cause the first UE to receive an indication of a resource pool of resources available for sidelink communication with the first UE, receive, from a network entity, an indication of a sidelink communication configuration that is associated with a pattern of time resources of the resource pool in which the first UE is to transmit sidelink signaling, the pattern of time resources spanning multiple slots, and transmit one or more sidelink messages to a second UE in accordance with the pattern of time resources.

Another first UE is described. The first UE may include means for receiving an indication of a resource pool of resources available for sidelink communication with the first UE, means for receiving, from a network entity, an indication of a sidelink communication configuration that is associated with a pattern of time resources of the resource pool in which the first UE is to transmit sidelink signaling, the pattern of time resources spanning multiple slots, and means for transmitting one or more sidelink messages to a second UE in accordance with the pattern of time resources.

A non-transitory computer-readable medium storing code is described. The code may include instructions executable by a processor to receive an indication of a resource pool of resources available for sidelink communication with the first UE, receive, from a network entity, an indication of a sidelink communication configuration that is associated with a pattern of time resources of the resource pool in which the first UE is to transmit sidelink signaling, the pattern of time resources spanning multiple slots, and transmit one or more sidelink messages to a second UE in accordance with the pattern of time resources.

Some examples of the method, apparatuses, and non-transitory computer-readable medium described herein may further include operations, features, means, or instructions for transmitting sidelink control information including an indication of the pattern of time resources across the multiple slots and one or more indications of a device with which the first UE may be to communicate in each time resource of the pattern of time resources.

In some examples of the method, apparatuses, and non-transitory computer-readable medium described herein, the sidelink control information may be transmitted in one or more first symbols of the pattern of time resources and may be not repeated in the pattern of time resources.

In some examples of the method, apparatuses, and non-transitory computer-readable medium described herein, the pattern of time resources indicates a set of multiple start and length indicator values.

In some examples of the method, apparatuses, and non-transitory computer-readable medium described herein, the sidelink communication configuration indicates a selection of a start and length indicator value pattern of a set of multiple start and length indicator value patterns.

In some examples of the method, apparatuses, and non-transitory computer-readable medium described herein, the indication of the resource pool indicates a quantity of the multiple slots that may be spanned by the pattern of time resources.

In some examples of the method, apparatuses, and non-transitory computer-readable medium described herein, the indication of the sidelink communication configuration may be received via radio resource control signaling or downlink control information.

In some examples of the method, apparatuses, and non-transitory computer-readable medium described herein, the pattern of time resources indicates a gap symbol that may be a last symbol and an only gap symbol of the pattern of time resources, or both.

In some examples of the method, apparatuses, and non-transitory computer-readable medium described herein, a first symbol of the pattern of time resources may be an automatic gain control symbol that may be a repetition of a second symbol of the pattern of time resources.

In some examples of the method, apparatuses, and non-transitory computer-readable medium described herein, the pattern of time resources may be indicated in one or more slots, one or more mini-slots, or both.

A method is described. The method may include performing a sensing operation to determine available resources for sidelink communication with the first UE, transmitting sidelink control information that indicates a pattern of time resources of the available resources in which the first UE is to transmit sidelink signaling, where the pattern of time resources spans multiple slots, and transmitting one or more sidelink messages to a second UE in accordance with the pattern of time resources.

A first UE is described. The first UE may include one or more processors, memory coupled with the one or more processors, and instructions stored in the memory. The instructions may be executable by the processor to cause the first UE to perform a sensing operation to determine available resources for sidelink communication with the first UE, transmit sidelink control information that indicates a pattern of time resources of the available resources in which the first UE is to transmit sidelink signaling, where the pattern of time resources spans multiple slots, and transmit one or more sidelink messages to a second UE in accordance with the pattern of time resources.

Another first UE is described. The first UE may include means for performing a sensing operation to determine available resources for sidelink communication with the first UE, means for transmitting sidelink control information that indicates a pattern of time resources of the available resources in which the first UE is to transmit sidelink signaling, where the pattern of time resources spans multiple slots, and means for transmitting one or more sidelink messages to a second UE in accordance with the pattern of time resources.

A non-transitory computer-readable medium storing code is described. The code may include instructions executable by a processor to perform a sensing operation to determine available resources for sidelink communication with the first UE, transmit sidelink control information that indicates a pattern of time resources of the available resources in which the first UE is to transmit sidelink signaling, where the pattern of time resources spans multiple slots, and transmit one or more sidelink messages to a second UE in accordance with the pattern of time resources.

In some examples of the method, apparatuses, and non-transitory computer-readable medium described herein, the sidelink control information may be transmitted in one or more first symbols of the pattern of time resources, where the sidelink control information may be a lone sidelink control information of the pattern of time resources.

Some examples of the method, apparatuses, and non-transitory computer-readable medium described herein may further include operations, features, means, or instructions for receiving a set of multiple start and length indicator value patterns, where the pattern of time resources includes one of the set of multiple start and length indicator value patterns.

Some examples of the method, apparatuses, and non-transitory computer-readable medium described herein may further include operations, features, means, or instructions for receiving a resource pool indication that indicates a quantity of the multiple slots that may be spanned by the pattern of time resources.

In some examples of the method, apparatuses, and non-transitory computer-readable medium described herein, the pattern of time resources indicates a gap symbol that may be a last symbol and an only gap symbol of the pattern of time resources, or both.

Some examples of the method, apparatuses, and non-transitory computer-readable medium described herein may further include operations, features, means, or instructions for transmitting, in at least first symbol of a slot of the multiple slots other than a first slot of the multiple slots, a data transmission including a sidelink control information presence indication including one or more punctured resource elements, one or more punctured resource blocks, second sidelink control information of a format different than a format of the sidelink control information, one or more reference signals on one or more tones in the slot, or any combination thereof.

Some examples of the method, apparatuses, and non-transitory computer-readable medium described herein may further include operations, features, means, or instructions for transmitting an indication that that the sidelink control information presence indication will be included in the data transmission.

A method for wireless communication at a second UE is described. The method may include receiving an indication of a resource pool of resources available for sidelink communication with the second UE, receiving, from a network entity, an indication of a sidelink communication configuration that is associated with a pattern of time resources of the resource pool in which the second UE is to receive sidelink signaling, the pattern of time resources spanning multiple slots, and receiving one or more sidelink messages from a first UE in accordance with the pattern of time resources.

A second UE is described. The second UE may include one or more processors, memory coupled with the one or more processors, and instructions stored in the memory. The instructions may be executable by the processor to cause the second UE to receive an indication of a resource pool of resources available for sidelink communication with the second UE, receive, from a network entity, an indication of a sidelink communication configuration that is associated with a pattern of time resources of the resource pool in which the second UE is to receive sidelink signaling, the pattern of time resources spanning multiple slots, and receive one or more sidelink messages from a first UE in accordance with the pattern of time resources.

Another second UE is described. The second UE may include means for receiving an indication of a resource pool of resources available for sidelink communication with the second UE, means for receiving, from a network entity, an indication of a sidelink communication configuration that is associated with a pattern of time resources of the resource pool in which the second UE is to receive sidelink signaling, the pattern of time resources spanning multiple slots, and means for receiving one or more sidelink messages from a first UE in accordance with the pattern of time resources.

A non-transitory computer-readable medium storing code for wireless communication at a second UE is described. The code may include instructions executable by a processor to receive an indication of a resource pool of resources available for sidelink communication with the second UE, receive, from a network entity, an indication of a sidelink communication configuration that is associated with a pattern of time resources of the resource pool in which the second UE is to receive sidelink signaling, the pattern of time resources spanning multiple slots, and receive one or more sidelink messages from a first UE in accordance with the pattern of time resources.

Some examples of the method, apparatuses, and non-transitory computer-readable medium described herein may further include operations, features, means, or instructions for receiving sidelink control information including an indication of the pattern of time resources across the multiple slots and one or more indications of a device with which the first UE may be to communicate in each time resource of the pattern of time resources.

In some examples of the method, apparatuses, and non-transitory computer-readable medium described herein, the sidelink control information may be received in one or more first symbols of the pattern of time resources and may be not repeated in the pattern of time resources.

In some examples of the method, apparatuses, and non-transitory computer-readable medium described herein, the pattern of time resources indicates a set of multiple start and length indicator values.

In some examples of the method, apparatuses, and non-transitory computer-readable medium described herein, the sidelink communication configuration indicates a selection of a start and length indicator value pattern of a set of multiple start and length indicator value patterns.

In some examples of the method, apparatuses, and non-transitory computer-readable medium described herein, the indication of the resource pool indicates a quantity of the multiple slots that may be spanned by the pattern of time resources.

In some examples of the method, apparatuses, and non-transitory computer-readable medium described herein, the indication of the sidelink communication configuration may be received via radio resource control signaling or downlink control information.

In some examples of the method, apparatuses, and non-transitory computer-readable medium described herein, the pattern of time resources indicates a gap symbol that may be a last symbol and an only gap symbol of the pattern of time resources, or both.

In some examples of the method, apparatuses, and non-transitory computer-readable medium described herein, a first symbol of the pattern of time resources may be an automatic gain control symbol that may be a repetition of a second symbol of the pattern of time resources.

In some examples of the method, apparatuses, and non-transitory computer-readable medium described herein, the pattern of time resources may be indicated in one or more slots, one or more mini-slots, or both.

A method is described. The method may include receiving sidelink control information that indicates a pattern of time resources of the available resources in which the second UE is to receive sidelink signaling, where the pattern of time resources spans multiple slots and receiving one or more sidelink messages from a first UE in accordance with the pattern of time resources.

A second UE is described. The second UE may include one or more processors, memory coupled with the one or more processors, and instructions stored in the memory. The instructions may be executable by the processor to cause the second UE to receive sidelink control information that indicates a pattern of time resources of the available resources in which the second UE is to receive sidelink signaling, where the pattern of time resources spans multiple slots and receive one or more sidelink messages from a first UE in accordance with the pattern of time resources.

Another second UE is described. The second UE may include means for receiving sidelink control information that indicates a pattern of time resources of the available resources in which the second UE is to receive sidelink signaling, where the pattern of time resources spans multiple slots and means for receiving one or more sidelink messages from a first UE in accordance with the pattern of time resources.

A non-transitory computer-readable medium storing code is described. The code may include instructions executable by a processor to receive sidelink control information that indicates a pattern of time resources of the available resources in which the second UE is to receive sidelink signaling, where the pattern of time resources spans multiple slots and receive one or more sidelink messages from a first UE in accordance with the pattern of time resources.

In some examples of the method, apparatuses, and non-transitory computer-readable medium described herein, the sidelink control information may be received in one or more first symbols of the pattern of time resources, where the sidelink control information may be a lone sidelink control information of the pattern of time resources.

Some examples of the method, apparatuses, and non-transitory computer-readable medium described herein may further include operations, features, means, or instructions for receiving a set of multiple start and length indicator value patterns, where the pattern of time resources includes one of the set of multiple start and length indicator value patterns.

Some examples of the method, apparatuses, and non-transitory computer-readable medium described herein may further include operations, features, means, or instructions for receiving a resource pool indication that indicates a quantity of the multiple slots that may be spanned by the pattern of time resources.

In some examples of the method, apparatuses, and non-transitory computer-readable medium described herein, the pattern of time resources indicates a gap symbol that may be a last symbol and an only gap symbol of the pattern of time resources, or both.

Some examples of the method, apparatuses, and non-transitory computer-readable medium described herein may further include operations, features, means, or instructions for receiving, in at least first symbol of a slot of the multiple slots other than a first slot of the multiple slots, a data transmission including a sidelink control information presence indication including one or more punctured resource elements, one or more punctured resource blocks, second sidelink control information of a format different than a format of the sidelink control information, one or more reference signals on one or more tones in the slot, or any combination thereof.

Some examples of the method, apparatuses, and non-transitory computer-readable medium described herein may further include operations, features, means, or instructions for receiving an indication that that the sidelink control information presence indication will be included in the data transmission.

### BRIEF DESCRIPTION OF THE DRAWINGS

FIG. 1 illustrates an example of a wireless communications system that supports multi-slot sidelink slot format and scheduling in accordance with one or more examples as disclosed herein.

FIGS. 2A and 2B illustrate examples of sidelink slot schemes that supports multi-slot sidelink slot format and scheduling in accordance with one or more examples as disclosed herein.

FIG. 3 illustrates an example of a wireless communications system that supports multi-slot sidelink slot format and scheduling in accordance with one or more examples as disclosed herein.

FIGS. 4A, 4B, and 4C illustrate examples of sidelink slot schemes that supports multi-slot sidelink slot format and scheduling in accordance with one or more examples as disclosed herein.

FIG. 5 illustrates an example of a process flow that supports multi-slot sidelink slot format and scheduling in accordance with one or more examples as disclosed herein.

FIG. 6 illustrates an example of a process flow that supports multi-slot sidelink slot format and scheduling in accordance with one or more examples as disclosed herein.

FIGS. 7 and 8 illustrate block diagrams of devices that support multi-slot sidelink slot format and scheduling in accordance with one or more examples as disclosed herein.

FIG. 9 illustrates a block diagram of a communications manager that supports multi-slot sidelink slot format and scheduling in accordance with one or more examples as disclosed herein.

FIG. 10 illustrates a diagram of a system including a device that supports multi-slot sidelink slot format and scheduling in accordance with one or more examples as disclosed herein.

FIGS. 11 through 14 illustrate flowcharts showing methods that support multi-slot sidelink slot format and scheduling in accordance with one or more aspects of the present disclosure.

### DETAILED DESCRIPTION

Sidelink communications may involve a variety of different communications applications, including ultra reliable low latency communications (URLLC), industrial internet of things (IIOT), and extended reality (XR) services. These and other communications applications may involve a diverse set of latency and reliability considerations. For example, some applications employ tight latency parameters and relaxed reliability parameters, some applications involve stringent reliability parameters and relaxed latency parameters, and yet other applications involve both stringent latency parameters and stringent reliability parameters. For example, XR applications may consume data in larger units (e.g., application data units (ADUs)) than other applications (e.g., that may use packet data units (PDUs)), because XR applications may involve burst transmissions of multiple packets that have similar characteristics (e.g., latency, reliability, or other characteristics). Therefore, new sidelink communication schemes to handle such diverse applications and use cases may be desirable.

A sidelink UE may employ a multi-slot format in which the UE communicates with one or more other UEs over the course of the multiple slots. A pattern of time resources that may define with which devices the sidelink UE may communicate may be received from a network entity (e.g., in sidelink mode 1 resource allocation) or may be autonomously determined by the UE (e.g., in sidelink mode 2 resource allocation). The sidelink UE transmits a single instance of sidelink control information (SCI) to receiving UEs and the SCI indicates the pattern of time resources and respective assignments for transmission and reception.

In some examples, the multi-slot format may include or omit various symbols, including automatic gain control (AGC) symbols, gap symbols, SCI symbols, etc. In sidelink mode 2 resource allocation, SCI symbols may be removed from a slot other than the first slot of the multi-slot format, but a receiving UE may not be aware of the SCI transmitted at the beginning of the multi-slot format. As such, the multi-slot format may include indications in symbols where the receiving UE expects the SCI symbol(s) to be to indicate that the SCI symbol(s) were transmitted at the beginning of the multi-slot slot format. In this way, UEs communicating in sidelink may better adapt to different characteristics (e.g., delay characteristics, latency characteristics, reliability characteristics, one or more other characteristics, or any combination thereof) of various applications by employing the multi-slot slot format, thereby resulting in improved speed and reliability of service for such applications.

Aspects of the disclosure are initially described in the context of wireless communications systems. Aspects of the disclosure are then described with reference to sidelink slot schemes, a wireless communications system, additional sidelink slot schemes, and process flows. Aspects of the disclosure are further illustrated by and described with reference to apparatus diagrams, system diagrams, and flowcharts that relate to multi-slot sidelink slot format and scheduling.

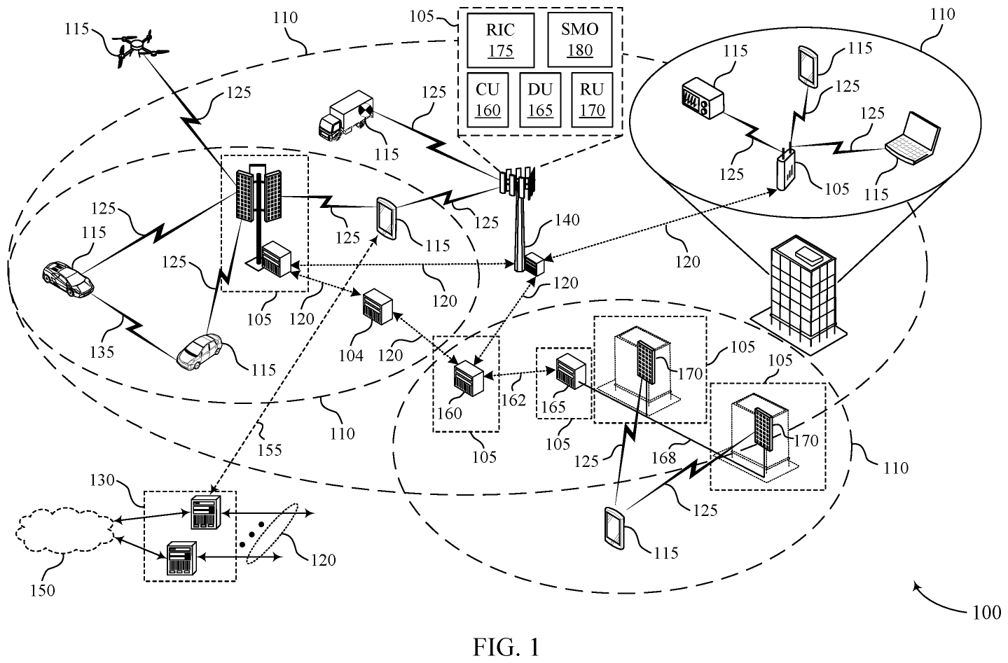

FIG. 1 illustrates an example of a wireless communications system 100 that supports multi-slot sidelink slot format and scheduling in accordance with one or more examples as disclosed herein. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support multi-slot sidelink slot format and scheduling as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, a UE 115 may communicate via sidelink communications with another UE 115 using a slot format that may span multiple slots. In some examples, the UE 115 may receive (e.g., from a network entity 105) information about resource allocation for the sidelink communications (e.g., an indication of available resources for the sidelink communications, an indication of a sidelink communication configuration, or both). In other examples, the UE 115 may autonomously determine and allocate resources for the sidelink communications (e.g., by performing a sensing operation). In some examples, the UE 115 may transmit SCI that may indicate a pattern of time resources that may span multiple slots and the time resources may include one or more designations of time resources for one or more data transmissions. The UE 115 may transmit (e.g., to another UE 115) one or more sidelink messages in accordance with the pattern of time resources.

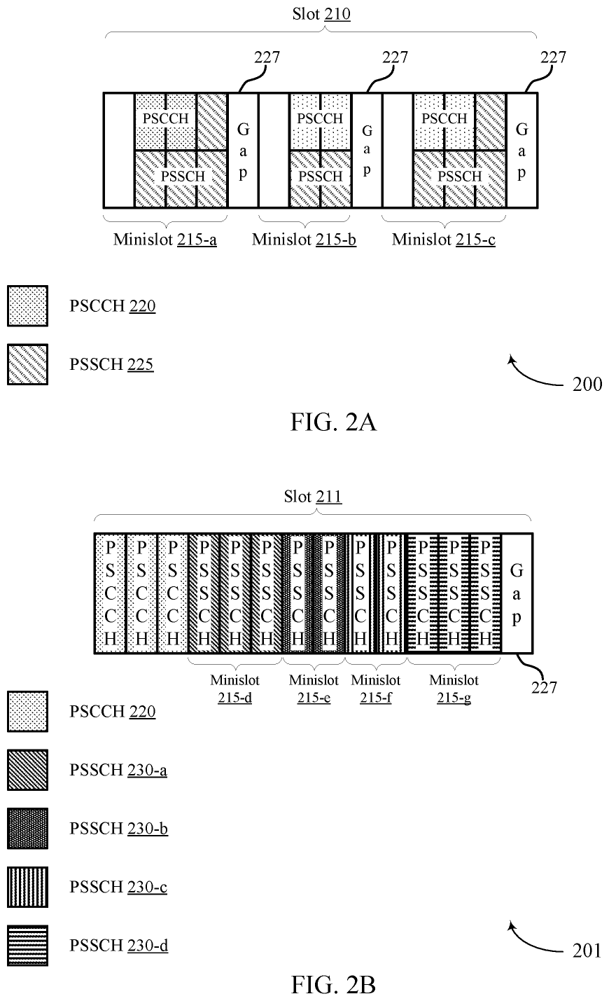

FIGS. 2A and 2B illustrate examples of sidelink slot scheme 200 and sidelink slot scheme 201 that support multi-slot sidelink slot format and scheduling in accordance with one or more examples as disclosed herein.

Different applications of wireless technologies may involve different latency or reliability considerations. For example, URLLC communications, IIOT communications, and XR communications may involve different latency or reliability considerations. Some applications may involve tighter latency considerations while reliability considerations are relaxed, some applications may involve stringent reliability while the latency considerations are relaxed, and some others may involve stringent latency and reliability considerations. As sidelink communications become more common in additional use cases, additional sidelink communication schemes, including schemes for slot formats and reservations, may be desirable.

For example, XR applications may consume data in larger-sized units of data (e.g., application data units (ADU)) as compared to smaller-sized units of data (e.g., packet data units (PDUs)). For example, an ADU may include one or more PDUs, and an ADU may also be referred to as a PDU set. A PDU set or ADU may include one or more PDUs carrying a payload of one unit of information that may be generated at the application level (e.g., a frame or video slice). In some examples, a burst may include one or more ADUs or PDU sets used for communications in XR applications or other applications.

In some examples, different slot structures may be employed. For example, a slot, such as slot 210, may include a quantity of symbols (e.g., 14 symbols) that may be OFDM symbols. However, in some examples, such as in sidelink communications, a slot 210 may occupy fewer than 14 symbols. In some examples, a first symbol of a slot 210 may be a repetition of a preceding symbol that may be used for setting one or more AGC parameters. In some examples, a gap symbol 227 may be scheduled following one or more PSSCH 220 symbols. In some examples, a sub-channel size may be configured or pre-configured to a quantity of PRBs, such as 10, 15, 20, 25, 50, 75, or 100 PRBs. In some examples, one or more PSCCH 220 symbols and one or more PSSCH 225 symbols may be transmitted together in a slot 210.

In some examples, one or more symbols for transmitting feedback information (e.g., associated with a physical sidelink feedback channel (PSFCH), such as a PSFCH symbol) may be scheduled in the slot 210. Such feedback symbols may be transmitted periodically (e.g., every 0, 1, 2, or 4 slots). In some examples, a second PSFCH symbol may be a repetition of a first PSFCH symbol used for setting one or more AGC parameters. In some examples, a gap symbol 227 may be scheduled after a PSFCH symbol.

In some examples, one or more PSCCH 220 symbols may be used to transmit SCI. SCI may include two stages for forward compatibility. A first stage (e.g., SCI-1) may be transmitted on a PSCCH and may include information for resource allocation and decoding second stage control. A second stage (e.g., SCI-2) may be transmitted on a PSSCH and may include information for decoding data (e.g., shared channel data). In some examples, the first stage may be decodable by UEs without capabilities for decoding two stage SCI, whereas the second stage may be decodable by UEs that include a capability for decoding two stage SCI.

In some examples, the first stage of SCI (e.g., SCI-1) may include priority information (e.g., one or more quality of service values), a PSSCH resource assignment (e.g., one or more time resources, one or more frequency resources, or both, for PSSCH transmissions), one or more resource reservation periods (e.g., if so enabled), one or more PSSCH DMRS patterns (e.g., if one or more such patterns are configured or preconfigured), an indication of a second SCI format (e.g., that may include information related to a size of the second SCI), a beta offset (e.g., a two bit beta offset) associated with second stage control resource allocations, an indication of a quantity of PSSCH DMRS ports (e.g., 1 or 2), an indication of a modulation and coding scheme (MCS) (e.g., a five bit MCS), or any combination thereof.

The sidelink slot scheme 200 depicts the use of minislot 215-a, minislot 215-b, and minislot 215-c within the slot 210. In such an arrangement, each slot, such as slot 210, may be split into multiple minislots 215, where each minislot 215 of the sidelink slot scheme 200 may include PSCCH 220 signaling, PSSCH 225 signaling, or both, and the minislots 215 may be separated by one or more gap symbols 227. In some examples, each minislot may be individually schedulable and decodable. For example, a UE may select or reserve one or more minislots 215 per slot 210 for communications.

The use of such minislots 215 may reduce scheduling and turn-around time for sidelink communications. For example, as the quantity of minislots 215 used per slot 210 increases (e.g., which may enhance scheduling latency or may be suitable for small packets, such as for IIOT applications), more symbols may be allocated to gap symbols 227. For some use cases (e.g., if a large quantity of UEs is to be supported) such overhead may affect latency reduction gains.

In some examples, the sidelink slot scheme 200 may include allocation details in PSCCH 220 signaling about which minislots (e.g., minislot 215-d, minislot 215-e, minislot 215-f, minislot 215-g, or any combination thereof) may be scheduled or used by a transmitting UE in sidelink communications with a receiving UE. For example, different minislots may be used for transmissions to different receiving UEs, or multiple minislots may be used for transmissions to a same receiving UE. In some examples, details about retransmission of one or more scheduled transmissions may be included in the PSCCH 220 signaling corresponding to the receiving UE that is scheduled to receive the PSCCH 220, the PSSCH 225 signaling, or both, in a given minislot. In some examples, a PSCCH 220 transmission (e.g., including SCI) made in a minislot may include details for a transmission to be made in the same minislot, whereas in other examples, a PSCCH 220 transmission in a minislot may include details for all transmissions to be made within the slot 210, even those to be made in a minislot different than the minislot in which the PSCCH 220 transmission is made.

The sidelink slot scheme 201 depicts the use of minislot 215-d, minislot 215-e, minislot 215-f, and minislot 215-g within the slot 211. In some examples, the slot 211 may be split into minislot 215-d (e.g., associated with PSSCH 230-a symbols or transmissions), minislot 215-e (e.g., associated with PSSCH 230-b symbols or transmissions), minislot 215-f (e.g., associated with PSSCH 230-c symbols or transmissions), and minislot 215-g (e.g., associated with PSSCH 230-d symbols or transmissions) based on a resource pattern. For example, the resource pattern may indicate a quantity of minislots to be used in the slot 211, a length for one or more of the minislots 215, or both. In some examples, the slot 211 may include the PSCCH 220 signaling at the beginning of the slot 211 and the PSCCH 220 signaling may include SCI. The PSCCH 220 signaling may indicate transmission or reservation of one or more minislots in the same slot 211 or in one or more subsequent slots. In some examples, the slot 211 may not include a symbol for AGC determinations, as a receiving device may perform an AGC determination using the first symbol of the slot 211 and use the results of the AGC determination for reception of any or all of minislot 215-d, minislot 215-e, minislot 215-f, and minislot 215-g.

In some examples, the gap symbol 227 may be included at the end of the slot 211. In some examples, gap symbols 227 may be used to allow for a transition between transmitting and receiving or between receiving and transmitting.

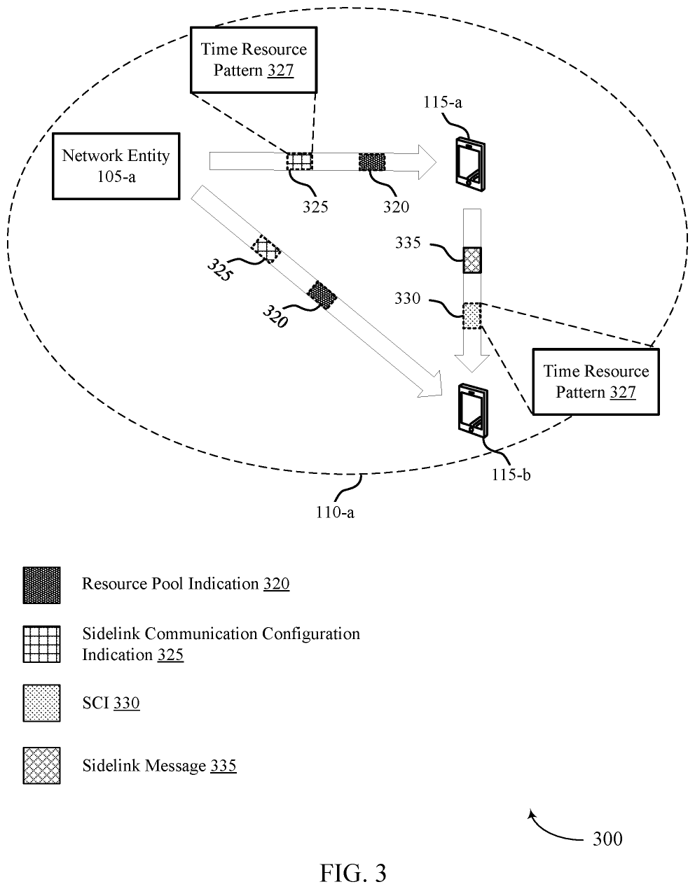

FIG. 3 illustrates an example of a wireless communications system 300 that supports multi-slot sidelink slot format and scheduling in accordance with one or more examples as disclosed herein. The wireless communications system 300 may include UE 115-a, UE 115-b, and network entity 105-a. The UE 115-a and the UE 115-b may communicate via sidelink communications. The network entity 105-a may communicate with the UE 115-a, the UE 115-b, or both, via uplink communications, downlink communications, or both. The UE 115-a, the UE 115-b, or both may operate within a coverage area 110-a associated with the network entity 105-a.

In some examples, the network entity 105-a, the UE 115-a, and UE 115-b may operate in a first resource allocation mode (e.g., Mode 1 DG) in which the network entity 105-a allocates resources (e.g., one or more slots, optionally with at least two consecutive slots) for the sidelink communications between the UE 115-a and the UE 115-b. For example, the UE 115-a, the UE 115-b, or both, may receive (e.g., via control signaling, such as RRC, DCI, or MAC-CE signaling) a resource pool indication 320 that indicates one or more resources that may be available to the UE 115-a and the UE 115-b for sidelink communications.

The UE 115-a, the UE 115-b, or both, may receive (e.g., via control signaling, such as RRC, DCI (such as DCI format 3_x), or MAC-CE signaling) from the network entity 105-a, a sidelink communication configuration indication 325 for sidelink communications that may indicate or be associated with the time resource pattern 327. The time resource pattern 327 may indicate or schedule one or more resources of the resource pool (e.g., one or more slots, one or more minislots, or both) that are assigned to the UE 115-a for sidelink communications between the UE 115-a and the UE 115-b, one or more other devices, or both. For example, the time resource pattern 327 may schedule or indicate resources for the UE 115-a to communicate with the UE 115-b in one or more minislots and to communicate with another UE in one or more different minislots. In some examples, the UE 115-a may receive an indication of a quantity of slots that are to be included in the time resource pattern 327, a quantity of minislots that are to be included in the time resource pattern 327, or both. In some examples, the time resource pattern 327 may span multiple slots. For example, the one or more minislots of the slots may be distributed across time resources corresponding to the multiple slots.

The UE 115-a may then transmit one or more sidelink messages 335 to the

UE 115-b in accordance with the time resource pattern 327. For example, the UE 115-a may transmit the one or more sidelink messages 335 to the UE 115-b within the time resources allocated or scheduled in the time resource pattern 327 for sidelink communications between the UE 115-a and the UE 115-b.

In some examples, the network entity 105-a may indicate which slots or minislots of those allocated or scheduled slots or minislots are to be retransmitted, a quantity of such retransmissions (e.g., for each indicated resource), an indications of retransmission of one or more transport blocks of the allocated or scheduled resources, or any combination thereof. In some examples, the network entity 105-a may do so based on knowledge of a delay parameters, one or more packet delay budgets (PDBs) associated with packets that are associated with a transmitting UE (e.g., the UE 115-a), or both. In some examples, the network entity 105-a may receive or determine information about delay (e.g., a delay parameter, such as Twait, a PDB, or both) associated with packets to be retransmitted by the UE 115-a to the UE 115-b

In some examples, the UE 115-a and the UE 115-b may operate in a second resource allocation mode (e.g., a Mode 2 allocation mode) in which a transmitting UE (e.g., the UE 115-a) may determine and schedule one or more resources to be used for sidelink communications between the UE 115-a and the UE 115-b. For example, the UE 115-a may perform a sensing operation to determine one or more resources that may be available for the sidelink communications.

The UE 115-a may transmit SCI 330 to the UE 115-b. The SCI 330 may include the time resource pattern 327 that may indicate or schedule one or more time resources (e.g., one or more slots, one or more minislots, or both) optionally determined as a result of the sensing operation, that are assigned to the UE 115-a for sidelink communications between the UE 115-a and the UE 115-b, one or more other devices, or both. For example, the time resource pattern 327 may schedule or indicate resources for the UE 115-a to communicate with the UE 115-b in one or more minislots and to communicate with another UE in one or more different minislots. The time resource pattern 327 may further indicate a quantity of slots, a quantity of minislots, or both that are to be used for the sidelink communications between the UE 115-a and the UE 115-b. In some examples, the time resource pattern 327 may span multiple slots. For example, the one or more minislots of the slots may be distributed across time resources corresponding to the multiple slots.

The UE 115-a may transmit one or more sidelink messages 335 to the UE 115-b in accordance with the time resource pattern 327. For example, the UE 115-a may transmit the one or more sidelink messages 335 to the UE 115-b within the time resources allocated or scheduled in the time resource pattern 327 for sidelink communications between the UE 115-a and the UE 115-b.

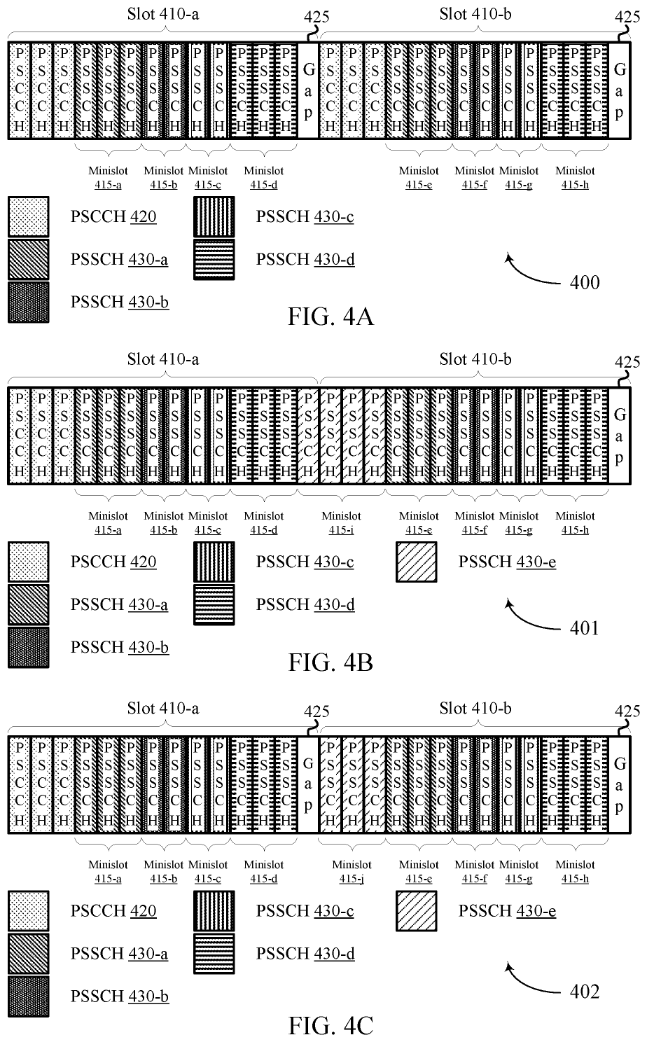

FIG. 4A, 4B, and 4C illustrate examples of sidelink slot scheme 400, sidelink slot scheme 401, and sidelink slot scheme 402 that support multi-slot sidelink slot format and scheduling in accordance with one or more examples as disclosed herein.

Various examples of sidelink slot schemes are depicted in FIGS. 4A, 4B, and 4C. However, in some examples, sidelink slot scheme 400, sidelink slot scheme 401, and sidelink slot scheme 402 may include one or more common characteristics. For example, PSSCH 420 signaling (e.g., including SCI) for slot 410-a, slot 410-b, or both, may include allocation details (e.g., that may include an indication of a pattern of time resources over one or more slots, such as slots 410-a and 410-b) in PSCCH 420 signaling about which minislots 415 may be scheduled or used by a transmitting UE in sidelink communications with a receiving UE. For example, different minislots may be used for transmissions to different receiving UEs, or multiple minislots may be used for transmissions to a same receiving UE. In some examples, the PSSCH 420 signaling may include a bitmap or one or more bit allocations to indicate which minislots are to be used by the transmitting UE for communications with a receiving UE. In some examples, details about retransmission of one or more scheduled transmissions may be included in the PSCCH 420 signaling corresponding to the receiving UE that is scheduled to receive the PSCCH 420, the various PSSCH 430 transmissions (e.g., PSCCH 430-a transmissions associated with minislot 415-a, minislot 415-e, or both; the PSCCH 430-b transmissions associated with minislot 415-b, minislot 415-f, or both; the PSCCH 430-c transmissions associated with minislot 415-c, minislot 415-g, or both; the PSCCH 430-d transmissions associated with minislot 415-d, minislot 415-h, or both; and so on), or both, in a given minislot. In other examples, one or more PSCCH 420 transmissions may include allocation details just for the one or more minislots for a given receiving UE or may include allocation details for all minislots in one or more slots covered by the allocation details or the pattern of time resources.

FIG. 4A depicts an example sidelink slot scheme 400 in which a pattern of time resources spanning slot 410-a and slot 410-b is depicted. In this example, a gap symbol 425 may be included in the pattern of time resources at the end of slot 410-a and at the end of slot 410-b. As discussed herein, the pattern of time resources may schedule or indicate resources for a transmitting UE to communicate with a receiving UE in one or more minislots and to communicate with another UE in one or more different minislots.

FIG. 4B depicts another example sidelink slot scheme 401 that includes a pattern of time resources of a “long” slot (e.g., that spans multiple slots). In slot scheme 401, the structure of multiple symbols organized in multiple minislots 415 may be indicated, including a quantity of slots 410 spanned by the pattern of time resources, a quantity of minislots 415 included in the pattern of time resources, one or more lengths of one or more of the minislots 415, or any combination thereof.

In some examples, a network entity or a transmitting UE may define or indicate one or more start and length indicator values (SLIVs) and may indicate one or more lengths of the minislots 415 of the slot scheme 401. Additionally, or alternatively, the network entity or the transmitting UE may define or indicate one or more SLIV patterns, one or more minislot 415 patterns corresponding to one or more SLIV patterns, or both, for a resource pool. The network entity (e.g., in a scheme where the network entity allocates sidelink resources) or the transmitting UE (e.g., in a scheme where the transmitting UE allocates sidelink resources) may select an one or more SLIV patterns, one or more minislot patterns, or both, and may transmit an indication (e.g., via control signaling, such as RRC, DCI, MAC-CE, SCI, or other control signaling) to a receiving device to indicate the one or more SLIV patterns, one or more minislot patterns, or both to inform the receiving device of the resource allocation or scheduling for the sidelink communications.

In some examples, the sidelink slot scheme 401 may not include a gap symbol 425 at the end of the slot 410-a. As in other examples, the pattern of time resources may span slot 410-a and slot 410-b, and, as such, the gap symbol 425 may not be included at the end of slot 410-a. Additionally, or alternatively, the slot scheme 401 may include a gap symbol 425 only at a last symbol of a pattern of time resources or at an end of a last slot spanned by the pattern of time resources. In some examples, SCI may be transmitted in the one or more PSCCH 420 symbols. In some examples, one or more symbols at the beginning of the pattern of time resources may include a symbol for AGC determinations or calculations that may be applied for reception of one or more transmissions at one or more other points in the pattern of time resources. Such a symbol may be a repetition of another symbol.

In some examples, a single SCI or other control signaling that may indicate or include the pattern of time resources may be transmitted for the entire pattern of time resources. Additionally, or alternatively, one or more gap symbols 425, one or more PSCCH 420 transmissions, or both may be excluded from the pattern of time resources and may be replaced with one or more PSSCH 430 transmissions or symbols in the pattern of time resources. For example, the first gap symbol 425 and three PSCCH 420 symbols at the beginning of slot 410-b depicted in FIG. 4A were replaced with PSSCH 430 symbols associated with minislot 415-i in FIG. 4B.

In some examples, the pattern of time resources may include one or more symbols to be used for AGC determinations or calculations. Such one or more symbols may be repetitions of one or more previous or subsequent symbols

FIG. 4C depicts an example sidelink slot scheme 402 that may be employed in situations where a transmitting UE autonomously selects, allocates, or schedules sidelink resources. In the sidelink slot scheme 402, one or more PSCCH 420 symbols of a slot 410 other than the first slot (e.g., other than slot 410-a) may be removed and replaced with one or more PSSCH 430 symbols in the pattern of time resources. Additionally, or alternatively, a gap symbol 425 may be removed from the pattern of time resources and replaced with one or more PSSCH 430 symbols. For example, as shown in FIG. 4C, and as compared to FIG. 4A, the three PSCCH 420 symbols in FIG. 4A have been replaced with PSSCH 430-e symbols in minislot 415-j.

As PSCCH 420 symbols of a slot 410 other than the first slot of the pattern of time resources have been removed, if another UE begins to monitor the transmissions made in accordance with the pattern of time resources, the UE may be unable to identify such transmissions (e.g., because the PSCCH 420 symbols are not present at the beginning of slot 410-b). As such, the pattern of time resources may include or indicate one or more punctured resource elements (REs) or resource blocks (RBs) to one or more sub-channels where SCI or PSCCH 420 symbols may be expected, optionally using a low density pattern. Additionally, or alternatively, transmissions made in accordance with the pattern of time resources may include or indicate a reduced or modified SCI (or other control signaling) to aid in identification of the transmissions made in accordance with the pattern of time resources. Additionally, or alternatively, the transmissions made in accordance with the pattern of time resources may include one or more reference signals on one or more tones.

For example, a UE monitoring such transmissions may monitor for a control signaling transmission (e.g., SCI). If the UE does not receive such control signaling, the UE may then determine whether tones of the transmission are punctured or monitor for a modified or reduced control signaling format or a reference signal as described herein.

In some examples, a network entity or a UE transmitting in accordance with a pattern of time resources as described herein may indicate that tone puncturing, reduced or modified control signaling, or a reference signal may be used to indicate that the pattern of time resources spans multiple slots (e.g., as described in the various aspects of the subject matter described herein). For example, the network entity or UE may make such an indication using a flag (e.g., a flag such as a Rel18_SCI_existence flag). Additionally, or alternatively, the network entity may make such an indication via control signaling (e.g., L1 signaling, L2 signaling, L3, signaling, or any combination thereof). Additionally, or alternatively, the network entity may make such an indication as part of a resource pool configuration, such as within the resource pool indication 320 discussed in relation to FIG. 3. Additionally, or alternatively, the UE may make such an indication in a connected mode (e.g., an RRC connected mode), in association with establishing a connected mode, or via control signaling (e.g., L1 signaling, L2 signaling, L3, signaling, or any combination thereof).

monitoring such transmissions may

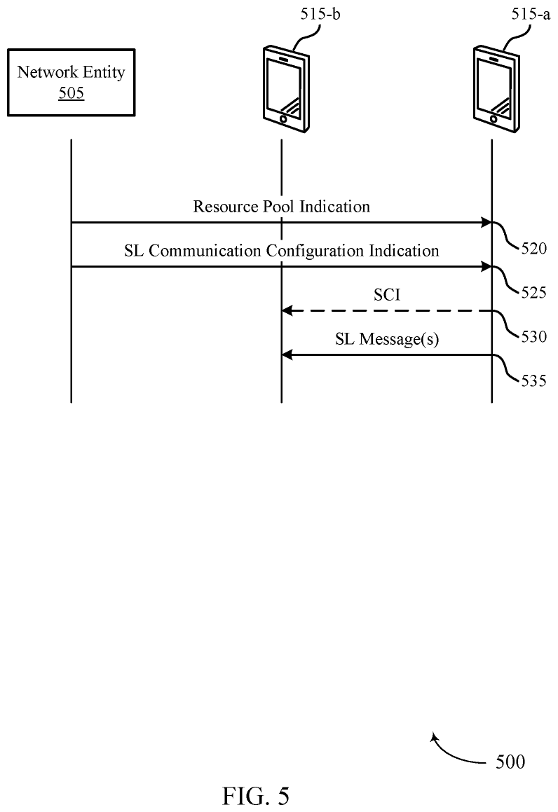

FIG. 5 illustrates an example of a process flow 500 that supports multi-slot sidelink slot format and scheduling in accordance with one or more examples as disclosed herein. The process flow 500 may implement various aspects of the present disclosure described herein. The elements described in the process flow 500 (e.g., the first UE 515-a, the second UE 515-b, the network entity 505, or any combination thereof) may be examples of similarly-named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or elements of the process flow 500 or by entities or elements that are not depicted in the process flow, or any combination thereof.

At 520, the first UE 515-a may receive an indication of a resource pool of resources available for sidelink communication with the first UE. In some examples, the indication of the resource pool may indicate a quantity of the multiple slots that are spanned by the pattern of time resources.

At 525, the first UE 515-a may receive, from a network entity, an indication of a sidelink communication configuration that is associated with a pattern of time resources of the resource pool in which the first UE is to transmit sidelink signaling, the pattern of time resources spanning multiple slots. In some examples, the pattern of time resources may indicate a plurality of start and length indicator values. In some examples, the sidelink communication configuration may indicate a selection of a start and length indicator value pattern of a plurality of start and length indicator value patterns. In some examples, the indication of the sidelink communication configuration is received via radio resource control signaling or downlink control information. In some examples, the pattern of time resources may indicate a gap symbol that is a last symbol and an only gap symbol of the pattern of time resources, or both. In some examples, a first symbol of the pattern of time resources is an automatic gain control symbol that is a repetition of a second symbol of the pattern of time resources. In some examples, the pattern of time resources is indicated in one or more slots, one or more mini-slots, or both.

At 530, the first UE 515-a may transmit sidelink control information that may include an indication of the pattern of time resources across the multiple slots and one or more indications of a device with which the first UE is to communicate in each time resource of the pattern of time resources.

At 535, the first UE 515-a may transmit one or more sidelink messages to the second UE 515-b in accordance with the pattern of time resources. In some examples, the sidelink control information is transmitted in one or more first symbols of the pattern of time resources and is not repeated in the pattern of time resources.

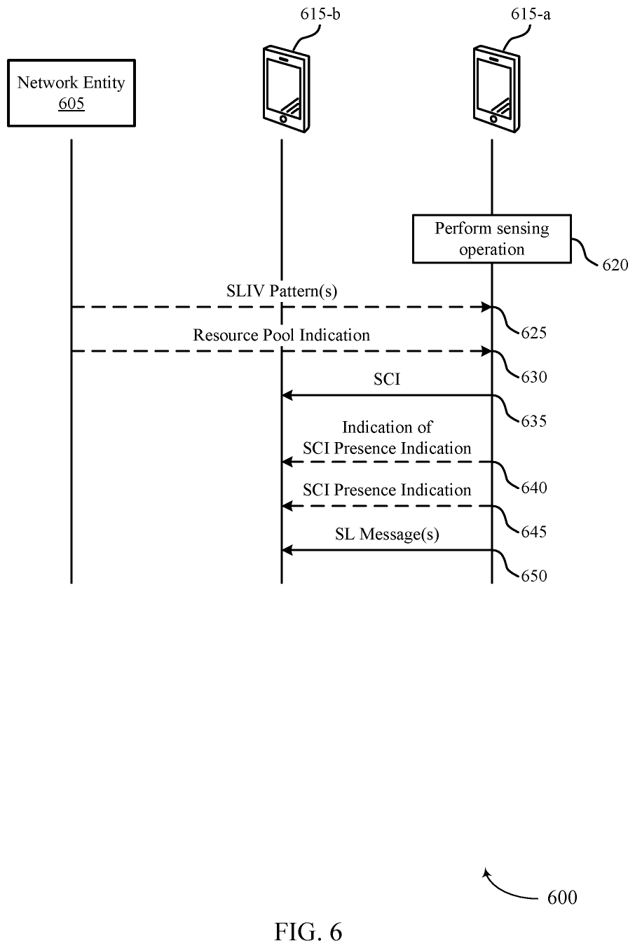

FIG. 6 illustrates an example of a process flow 600 that supports multi-slot sidelink slot format and scheduling in accordance with one or more examples as disclosed herein. The process flow 600 may implement various aspects of the present disclosure described herein. The elements described in the process flow 600 (e.g., the first UE 615-a, the second UE 615-b, the network entity 605, or any combination thereof) may be examples of similarly-named elements described herein.

In the following description of the process flow 600, the operations between the various entities or elements may be performed in different orders or at different times. Some operations may also be left out of the process flow 600, or other operations may be added. Although the various entities or elements are shown performing the operations of the process flow 600, some aspects of some operations may also be performed by other entities or elements of the process flow 600 or by entities or elements that are not depicted in the process flow, or any combination thereof.

At 620, the first UE 615-a may perform a sensing operation to determine available resources for sidelink communication with the first UE.

At 625, the first UE 615-a may receive a plurality of start and length indicator value patterns and the pattern of time resources may include one of the plurality of start and length indicator value patterns.

At 630, the first UE 615-a may receive a resource pool indication that may indicate a quantity of the multiple slots that are spanned by the pattern of time resources.

At 635, the first UE 615-a may transmit sidelink control information that may indicate a pattern of time resources of the available resources in which the first UE is to transmit sidelink signaling and the pattern of time resources spans multiple slots. In some examples, the sidelink control information is transmitted in one or more first symbols of the pattern of time resources. In some examples, the sidelink control information is a lone sidelink control information of the pattern of time resources. In some examples, the pattern of time resources may indicate a gap symbol that is a last symbol and an only gap symbol of the pattern of time resources, or both.

At 640, the first UE 615-a may transmit an indication that that the sidelink control information presence indication will be included in the data transmission.

At 645, transmit, in at least first symbol of a slot of the multiple slots other than a first slot of the multiple slots, a data transmission that may include a sidelink control information presence indication that may include one or more punctured resource elements, one or more punctured resource blocks, second sidelink control information of a format different than a format of the sidelink control information, one or more reference signals on one or more tones in the slot, or any combination thereof.

At 650, the first UE 615-a may transmit one or more sidelink messages to the second UE 615-b in accordance with the pattern of time resources.

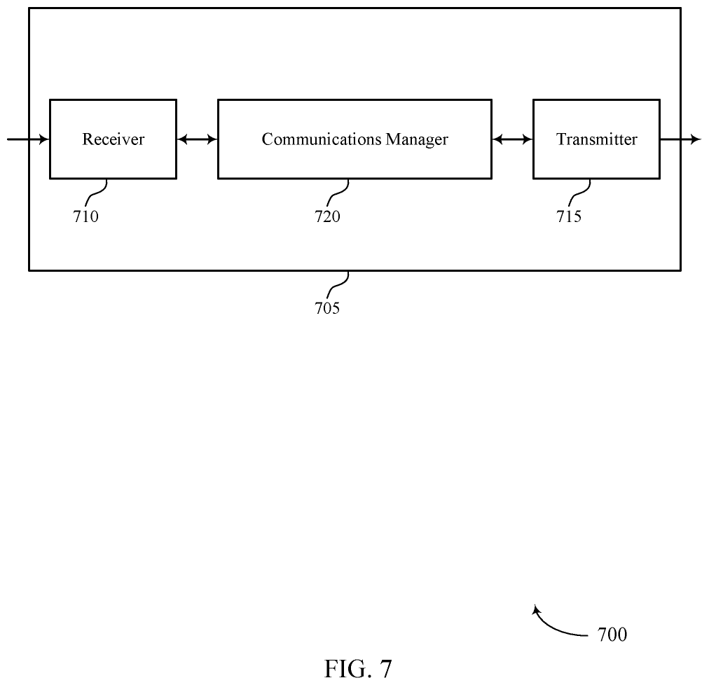

FIG. 7 illustrates a block diagram 700 of a device 705 that supports multi-slot sidelink slot format and scheduling in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to multi-slot sidelink slot format and scheduling). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to multi-slot sidelink slot format and scheduling). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of multi-slot sidelink slot format and scheduling as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

For example, the communications manager 720 may be configured as or otherwise support a means for receiving an indication of a resource pool of resources available for sidelink communication with the first UE. The communications manager 720 may be configured as or otherwise support a means for receiving, from a network entity, an indication of a sidelink communication configuration that is associated with a pattern of time resources of the resource pool in which the first UE is to transmit sidelink signaling, the pattern of time resources spanning multiple slots. The communications manager 720 may be configured as or otherwise support a means for transmitting one or more sidelink messages to a second UE in accordance with the pattern of time resources.

For example, the communications manager 720 may be configured as or otherwise support a means for performing a sensing operation to determine available resources for sidelink communication with the first UE. The communications manager 720 may be configured as or otherwise support a means for transmitting sidelink control information that indicates a pattern of time resources of the available resources in which the first UE is to transmit sidelink signaling, where the pattern of time resources spans multiple slots. The communications manager 720 may be configured as or otherwise support a means for transmitting one or more sidelink messages to a second UE in accordance with the pattern of time resources.

Additionally, or alternatively, the communications manager 720 may support wireless communication at a second UE in accordance with examples as disclosed herein. For example, the communications manager 720 may be configured as or otherwise support a means for receiving an indication of a resource pool of resources available for sidelink communication with the second UE. The communications manager 720 may be configured as or otherwise support a means for receiving, from a network entity, an indication of a sidelink communication configuration that is associated with a pattern of time resources of the resource pool in which the second UE is to receive sidelink signaling, the pattern of time resources spanning multiple slots. The communications manager 720 may be configured as or otherwise support a means for receiving one or more sidelink messages from a first UE in accordance with the pattern of time resources.

For example, the communications manager 720 may be configured as or otherwise support a means for receiving sidelink control information that indicates a pattern of time resources of the available resources in which the second UE is to receive sidelink signaling, where the pattern of time resources spans multiple slots. The communications manager 720 may be configured as or otherwise support a means for receiving one or more sidelink messages from a first UE in accordance with the pattern of time resources.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing, reduced power consumption, more efficient utilization of communication resources, or any combination thereof.

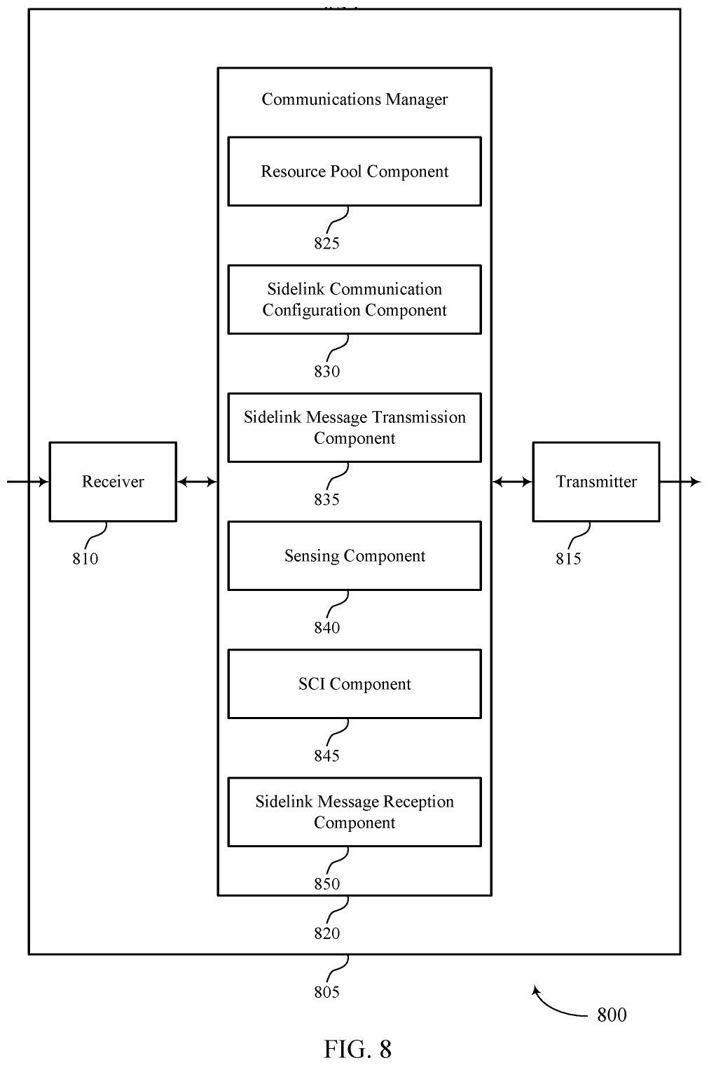

FIG. 8 illustrates a block diagram 800 of a device 805 that supports multi-slot sidelink slot format and scheduling in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to multi-slot sidelink slot format and scheduling). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to multi-slot sidelink slot format and scheduling). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of multi-slot sidelink slot format and scheduling as described herein. For example, the communications manager 820 may include a resource pool component 825, a sidelink communication configuration component 830, a sidelink message transmission component 835, a sensing component 840, an SCI component 845, a sidelink message reception component 850, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The resource pool component 825 may be configured as or otherwise support a means for receiving an indication of a resource pool of resources available for sidelink communication with the first UE. The sidelink communication configuration component 830 may be configured as or otherwise support a means for receiving, from a network entity, an indication of a sidelink communication configuration that is associated with a pattern of time resources of the resource pool in which the first UE is to transmit sidelink signaling, the pattern of time resources spanning multiple slots. The sidelink message transmission component 835 may be configured as or otherwise support a means for transmitting one or more sidelink messages to a second UE in accordance with the pattern of time resources.

The sensing component 840 may be configured as or otherwise support a means for performing a sensing operation to determine available resources for sidelink communication with the first UE. The SCI component 845 may be configured as or otherwise support a means for transmitting sidelink control information that indicates a pattern of time resources of the available resources in which the first UE is to transmit sidelink signaling, where the pattern of time resources spans multiple slots. The sidelink message transmission component 835 may be configured as or otherwise support a means for transmitting one or more sidelink messages to a second UE in accordance with the pattern of time resources.

Additionally, or alternatively, the communications manager 820 may support wireless communication at a second UE in accordance with examples as disclosed herein. The resource pool component 825 may be configured as or otherwise support a means for receiving an indication of a resource pool of resources available for sidelink communication with the second UE. The sidelink communication configuration component 830 may be configured as or otherwise support a means for receiving, from a network entity, an indication of a sidelink communication configuration that is associated with a pattern of time resources of the resource pool in which the second UE is to receive sidelink signaling, the pattern of time resources spanning multiple slots. The sidelink message reception component 850 may be configured as or otherwise support a means for receiving one or more sidelink messages from a first UE in accordance with the pattern of time resources.

The SCI component 845 may be configured as or otherwise support a means for receiving sidelink control information that indicates a pattern of time resources of the available resources in which the second UE is to receive sidelink signaling, where the pattern of time resources spans multiple slots. The sidelink message reception component 850 may be configured as or otherwise support a means for receiving one or more sidelink messages from a first UE in accordance with the pattern of time resources.

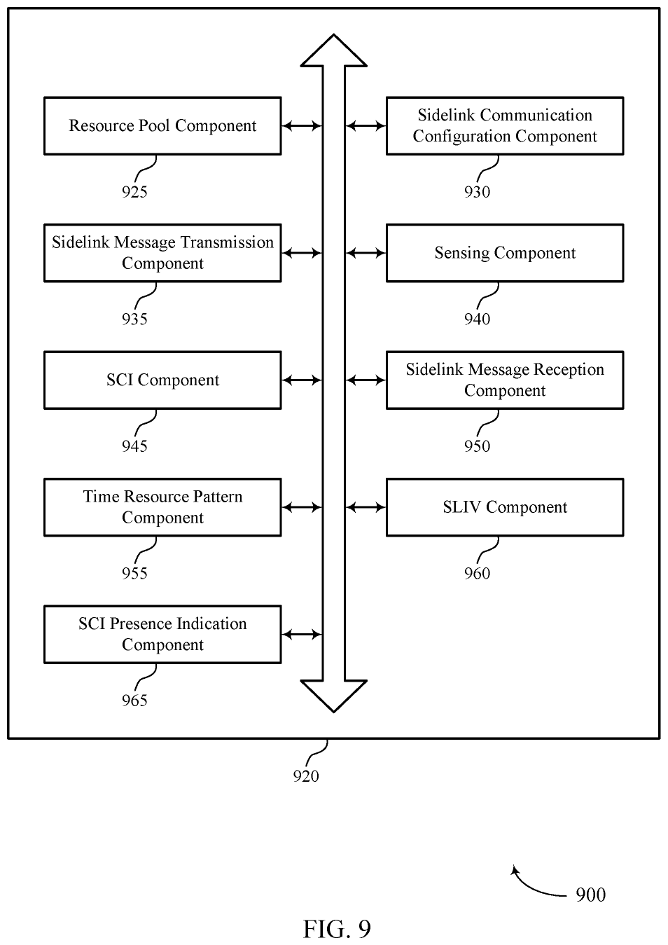

FIG. 9 illustrates a block diagram 900 of a communications manager 920 that supports multi-slot sidelink slot format and scheduling in accordance with one or more aspects of the present disclosure. The communications manager 920 may be an example of aspects of a communications manager 720, a communications manager 820, or both, as described herein. The communications manager 920, or various components thereof, may be an example of means for performing various aspects of multi-slot sidelink slot format and scheduling as described herein. For example, the communications manager 920 may include a resource pool component 925, a sidelink communication configuration component 930, a sidelink message transmission component 935, a sensing component 940, an SCI component 945, a sidelink message reception component 950, a time resource pattern component 955, an SLIV component 960, an SCI presence indication component 965, or any combination thereof. Each of these components may communicate, directly or indirectly, with one another (e.g., via one or more buses).

The resource pool component 925 may be configured as or otherwise support a means for receiving an indication of a resource pool of resources available for sidelink communication with the first UE. The sidelink communication configuration component 930 may be configured as or otherwise support a means for receiving, from a network entity, an indication of a sidelink communication configuration that is associated with a pattern of time resources of the resource pool in which the first UE is to transmit sidelink signaling, the pattern of time resources spanning multiple slots. The sidelink message transmission component 935 may be configured as or otherwise support a means for transmitting one or more sidelink messages to a second UE in accordance with the pattern of time resources.

In some examples, the SCI component 945 may be configured as or otherwise support a means for transmitting sidelink control information including an indication of the pattern of time resources across the multiple slots and one or more indications of a device with which the first UE is to communicate in each time resource of the pattern of time resources.

In some examples, the sidelink control information is transmitted in one or more first symbols of the pattern of time resources and is not repeated in the pattern of time resources.

In some examples, the pattern of time resources indicates a set of multiple start and length indicator values.

In some examples, the sidelink communication configuration indicates a selection of a start and length indicator value pattern of a set of multiple start and length indicator value patterns.

In some examples, the indication of the resource pool indicates a quantity of the multiple slots that are spanned by the pattern of time resources.

In some examples, the indication of the sidelink communication configuration is received via radio resource control signaling or downlink control information.

In some examples, the pattern of time resources indicates a gap symbol that is a last symbol and an only gap symbol of the pattern of time resources, or both.

In some examples, a first symbol of the pattern of time resources is an automatic gain control symbol that is a repetition of a second symbol of the pattern of time resources.

In some examples, the pattern of time resources is indicated in one or more slots, one or more mini-slots, or both.

The sensing component 940 may be configured as or otherwise support a means for performing a sensing operation to determine available resources for sidelink communication with the first UE. The SCI component 945 may be configured as or otherwise support a means for transmitting sidelink control information that indicates a pattern of time resources of the available resources in which the first UE is to transmit sidelink signaling, where the pattern of time resources spans multiple slots. In some examples, the sidelink message transmission component 935 may be configured as or otherwise support a means for transmitting one or more sidelink messages to a second UE in accordance with the pattern of time resources.

In some examples, the sidelink control information is transmitted in one or more first symbols of the pattern of time resources, where the sidelink control information is a lone sidelink control information of the pattern of time resources.

In some examples, the SLIV component 960 may be configured as or otherwise support a means for receiving a set of multiple start and length indicator value patterns, where the pattern of time resources includes one of the set of multiple start and length indicator value patterns.

In some examples, the resource pool component 925 may be configured as or otherwise support a means for receiving a resource pool indication that indicates a quantity of the multiple slots that are spanned by the pattern of time resources.

In some examples, the pattern of time resources indicates a gap symbol that is a last symbol and an only gap symbol of the pattern of time resources, or both.

In some examples, the SCI presence indication component 965 may be configured as or otherwise support a means for transmitting, in at least first symbol of a slot of the multiple slots other than a first slot of the multiple slots, a data transmission including a sidelink control information presence indication including one or more punctured resource elements, one or more punctured resource blocks, second sidelink control information of a format different than a format of the sidelink control information, one or more reference signals on one or more tones in the slot, or any combination thereof.

In some examples, the SCI presence indication component 965 may be configured as or otherwise support a means for transmitting an indication that that the sidelink control information presence indication will be included in the data transmission.

Additionally, or alternatively, the communications manager 920 may support wireless communication at a second UE in accordance with examples as disclosed herein. In some examples, the resource pool component 925 may be configured as or otherwise support a means for receiving an indication of a resource pool of resources available for sidelink communication with the second UE. In some examples, the sidelink communication configuration component 930 may be configured as or otherwise support a means for receiving, from a network entity, an indication of a sidelink communication configuration that is associated with a pattern of time resources of the resource pool in which the second UE is to receive sidelink signaling, the pattern of time resources spanning multiple slots. The sidelink message reception component 950 may be configured as or otherwise support a means for receiving one or more sidelink messages from a first UE in accordance with the pattern of time resources.

In some examples, the SCI component 945 may be configured as or otherwise support a means for receiving sidelink control information including an indication of the pattern of time resources across the multiple slots and one or more indications of a device with which the first UE is to communicate in each time resource of the pattern of time resources.

In some examples, the sidelink control information is received in one or more first symbols of the pattern of time resources and is not repeated in the pattern of time resources.

In some examples, the pattern of time resources indicates a set of multiple start and length indicator values.

In some examples, the sidelink communication configuration indicates a selection of a start and length indicator value pattern of a set of multiple start and length indicator value patterns.

In some examples, the indication of the resource pool indicates a quantity of the multiple slots that are spanned by the pattern of time resources.

In some examples, the indication of the sidelink communication configuration is received via radio resource control signaling or downlink control information.

In some examples, the pattern of time resources indicates a gap symbol that is a last symbol and an only gap symbol of the pattern of time resources, or both.

In some examples, a first symbol of the pattern of time resources is an automatic gain control symbol that is a repetition of a second symbol of the pattern of time resources.

In some examples, the pattern of time resources is indicated in one or more slots, one or more mini-slots, or both.

In some examples, the SCI component 945 may be configured as or otherwise support a means for receiving sidelink control information that indicates a pattern of time resources of the available resources in which the second UE is to receive sidelink signaling, where the pattern of time resources spans multiple slots. In some examples, the sidelink message reception component 950 may be configured as or otherwise support a means for receiving one or more sidelink messages from a first UE in accordance with the pattern of time resources.

In some examples, the sidelink control information is received in one or more first symbols of the pattern of time resources, where the sidelink control information is a lone sidelink control information of the pattern of time resources.

In some examples, the SLIV component 960 may be configured as or otherwise support a means for receiving a set of multiple start and length indicator value patterns, where the pattern of time resources includes one of the set of multiple start and length indicator value patterns.

In some examples, the resource pool component 925 may be configured as or otherwise support a means for receiving a resource pool indication that indicates a quantity of the multiple slots that are spanned by the pattern of time resources.

In some examples, the pattern of time resources indicates a gap symbol that is a last symbol and an only gap symbol of the pattern of time resources, or both.

In some examples, the SCI presence indication component 965 may be configured as or otherwise support a means for receiving, in at least first symbol of a slot of the multiple slots other than a first slot of the multiple slots, a data transmission including a sidelink control information presence indication including one or more punctured resource elements, one or more punctured resource blocks, second sidelink control information of a format different than a format of the sidelink control information, one or more reference signals on one or more tones in the slot, or any combination thereof.

In some examples, the SCI presence indication component 965 may be configured as or otherwise support a means for receiving an indication that that the sidelink control information presence indication will be included in the data transmission.

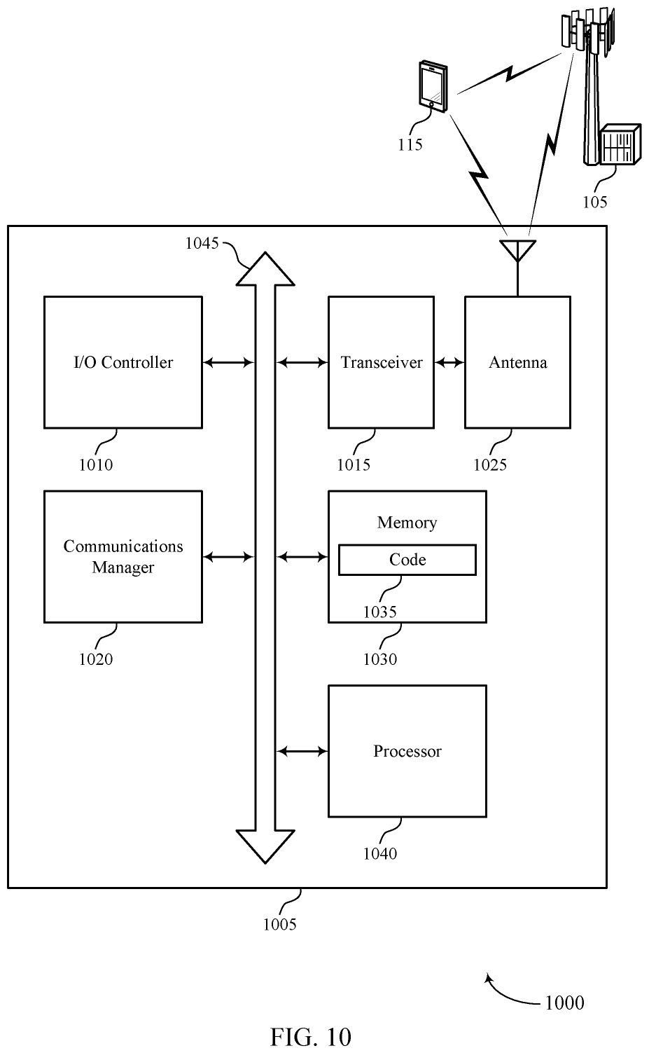

FIG. 10 illustrates a diagram of a system 1000 including a device 1005 that supports multi-slot sidelink slot format and scheduling in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting multi-slot sidelink slot format and scheduling). For example, the device 1005 or a component of the device 1005 may include a processor 1040 and memory 1030 coupled with or to the processor 1040, the processor 1040 and memory 1030 configured to perform various functions described herein.

For example, the communications manager 1020 may be configured as or otherwise support a means for receiving an indication of a resource pool of resources available for sidelink communication with the first UE. The communications manager 1020 may be configured as or otherwise support a means for receiving, from a network entity, an indication of a sidelink communication configuration that is associated with a pattern of time resources of the resource pool in which the first UE is to transmit sidelink signaling, the pattern of time resources spanning multiple slots. The communications manager 1020 may be configured as or otherwise support a means for transmitting one or more sidelink messages to a second UE in accordance with the pattern of time resources.

For example, the communications manager 1020 may be configured as or otherwise support a means for performing a sensing operation to determine available resources for sidelink communication with the first UE. The communications manager 1020 may be configured as or otherwise support a means for transmitting sidelink control information that indicates a pattern of time resources of the available resources in which the first UE is to transmit sidelink signaling, where the pattern of time resources spans multiple slots. The communications manager 1020 may be configured as or otherwise support a means for transmitting one or more sidelink messages to a second UE in accordance with the pattern of time resources.

Additionally, or alternatively, the communications manager 1020 may support wireless communication at a second UE in accordance with examples as disclosed herein. For example, the communications manager 1020 may be configured as or otherwise support a means for receiving an indication of a resource pool of resources available for sidelink communication with the second UE. The communications manager 1020 may be configured as or otherwise support a means for receiving, from a network entity, an indication of a sidelink communication configuration that is associated with a pattern of time resources of the resource pool in which the second UE is to receive sidelink signaling, the pattern of time resources spanning multiple slots. The communications manager 1020 may be configured as or otherwise support a means for receiving one or more sidelink messages from a first UE in accordance with the pattern of time resources.

For example, the communications manager 1020 may be configured as or otherwise support a means for receiving sidelink control information that indicates a pattern of time resources of the available resources in which the second UE is to receive sidelink signaling, where the pattern of time resources spans multiple slots. The communications manager 1020 may be configured as or otherwise support a means for receiving one or more sidelink messages from a first UE in accordance with the pattern of time resources.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of multi-slot sidelink slot format and scheduling as described herein, or the processor 1040 and the memory 1030 may be otherwise configured to perform or support such operations.

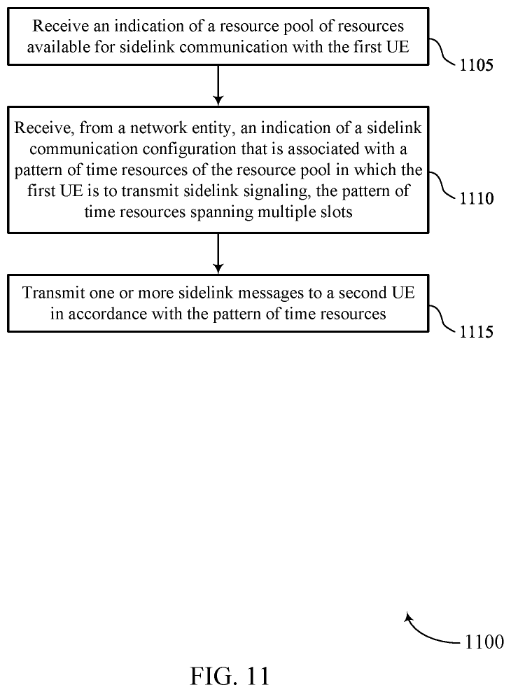

FIG. 11 illustrates a flowchart showing a method 1100 that supports multi-slot sidelink slot format and scheduling in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving an indication of a resource pool of resources available for sidelink communication with the first UE. The operations of 1105 may be performed in accordance with examples as disclosed herein. In some examples, aspects of the operations of 1105 may be performed by a resource pool component 925 as described with reference to FIG. 9.

At 1110, the method may include receiving, from a network entity, an indication of a sidelink communication configuration that is associated with a pattern of time resources of the resource pool in which the first UE is to transmit sidelink signaling, the pattern of time resources spanning multiple slots. The operations of 1110 may be performed in accordance with examples as disclosed herein. In some examples, aspects of the operations of 1110 may be performed by a sidelink communication configuration component 930 as described with reference to FIG. 9.

At 1115, the method may include transmitting one or more sidelink messages to a second UE in accordance with the pattern of time resources. The operations of 1115 may be performed in accordance with examples as disclosed herein. In some examples, aspects of the operations of 1115 may be performed by a sidelink message transmission component 935 as described with reference to FIG. 9.

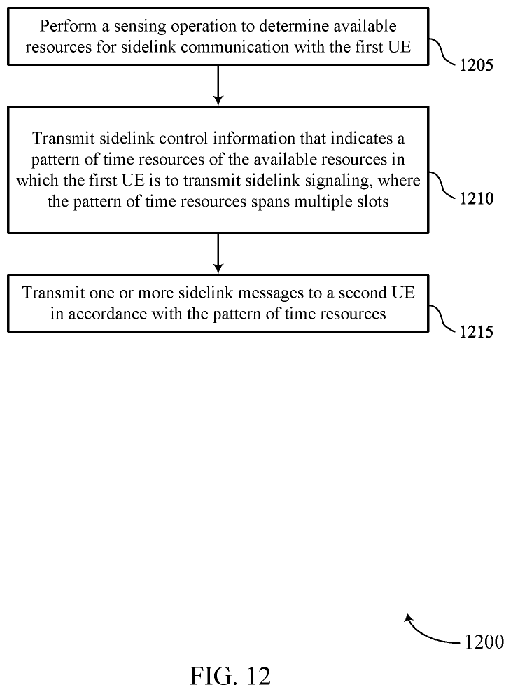

FIG. 12 illustrates a flowchart showing a method 1200 that supports multi-slot sidelink slot format and scheduling in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include performing a sensing operation to determine available resources for sidelink communication with the first UE. The operations of 1205 may be performed in accordance with examples as disclosed herein. In some examples, aspects of the operations of 1205 may be performed by a sensing component 940 as described with reference to FIG. 9.

At 1210, the method may include transmitting sidelink control information that indicates a pattern of time resources of the available resources in which the first UE is to transmit sidelink signaling, where the pattern of time resources spans multiple slots. The operations of 1210 may be performed in accordance with examples as disclosed herein. In some examples, aspects of the operations of 1210 may be performed by an SCI component 945 as described with reference to FIG. 9.

At 1215, the method may include transmitting one or more sidelink messages to a second UE in accordance with the pattern of time resources. The operations of 1215 may be performed in accordance with examples as disclosed herein. In some examples, aspects of the operations of 1215 may be performed by a sidelink message transmission component 935 as described with reference to FIG. 9.

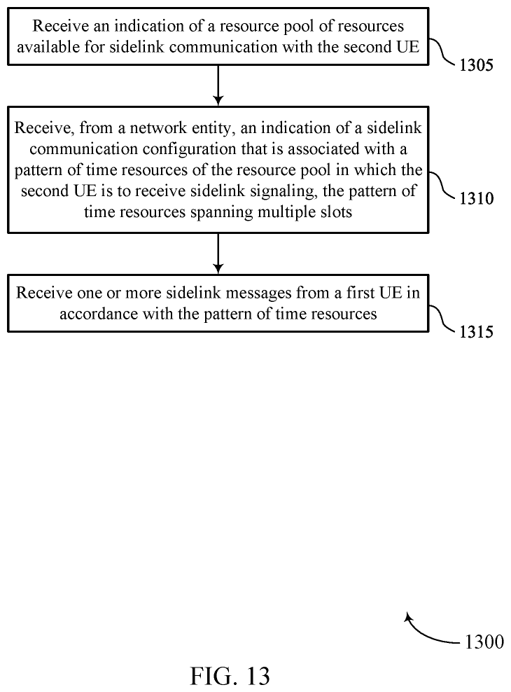

FIG. 13 illustrates a flowchart showing a method 1300 that supports multi-slot sidelink slot format and scheduling in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a resource pool of resources available for sidelink communication with the second UE. The operations of 1305 may be performed in accordance with examples as disclosed herein. In some examples, aspects of the operations of 1305 may be performed by a resource pool component 925 as described with reference to FIG. 9.

At 1310, the method may include receiving, from a network entity, an indication of a sidelink communication configuration that is associated with a pattern of time resources of the resource pool in which the second UE is to receive sidelink signaling, the pattern of time resources spanning multiple slots. The operations of 1310 may be performed in accordance with examples as disclosed herein. In some examples, aspects of the operations of 1310 may be performed by a sidelink communication configuration component 930 as described with reference to FIG. 9.

At 1315, the method may include receiving one or more sidelink messages from a first UE in accordance with the pattern of time resources. The operations of 1315 may be performed in accordance with examples as disclosed herein. In some examples, aspects of the operations of 1315 may be performed by a sidelink message reception component 950 as described with reference to FIG. 9.

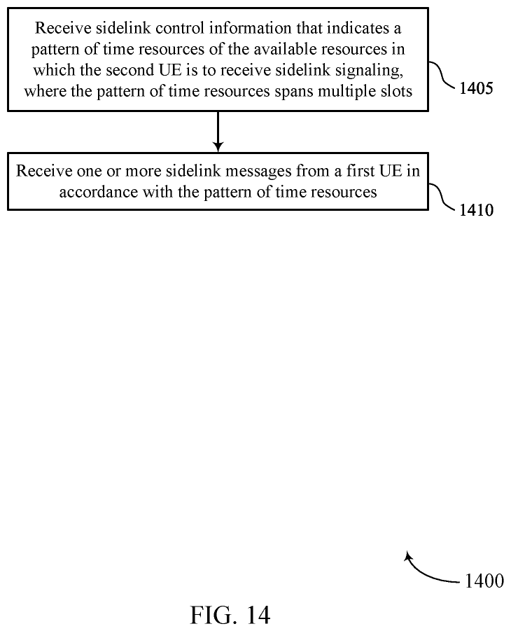

FIG. 14 illustrates a flowchart showing a method 1400 that supports multi-slot sidelink slot format and scheduling in accordance with one or more aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1405, the method may include receiving sidelink control information that indicates a pattern of time resources of the available resources in which the second UE is to receive sidelink signaling, where the pattern of time resources spans multiple slots. The operations of 1405 may be performed in accordance with examples as disclosed herein. In some examples, aspects of the operations of 1405 may be performed by an SCI component 945 as described with reference to FIG. 9.

At 1410, the method may include receiving one or more sidelink messages from a first UE in accordance with the pattern of time resources. The operations of 1410 may be performed in accordance with examples as disclosed herein. In some examples, aspects of the operations of 1410 may be performed by a sidelink message reception component 950 as described with reference to FIG. 9.

The following provides an overview of aspects of the present disclosure:

Aspect 1: A method for wireless communication at a first UE, comprising: receiving an indication of a resource pool of resources available for sidelink communication with the first UE; receiving, from a network entity, an indication of a sidelink communication configuration that is associated with a pattern of time resources of the resource pool in which the first UE is to transmit sidelink signaling, the pattern of time resources spanning multiple slots; and transmitting one or more sidelink messages to a second UE in accordance with the pattern of time resources.

Aspect 2: The method of aspect 1, further comprising: transmitting sidelink control information comprising an indication of the pattern of time resources across the multiple slots and one or more indications of a device with which the first UE is to communicate in each time resource of the pattern of time resources.

Aspect 3: The method of aspect 2, wherein the sidelink control information is transmitted in one or more first symbols of the pattern of time resources and is not repeated in the pattern of time resources.

Aspect 4: The method of any of aspects 1 through 3, wherein the pattern of time resources indicates a plurality of start and length indicator values.

Aspect 5: The method of any of aspects 1 through 4, wherein the sidelink communication configuration indicates a selection of a start and length indicator value pattern of a plurality of start and length indicator value patterns.

Aspect 6: The method of any of aspects 1 through 5, wherein the indication of the resource pool indicates a quantity of the multiple slots that are spanned by the pattern of time resources.

Aspect 7: The method of any of aspects 1 through 6, wherein the indication of the sidelink communication configuration is received via radio resource control signaling or downlink control information.

Aspect 8: The method of any of aspects 1 through 7, wherein the pattern of time resources indicates a gap symbol that is a last symbol and an only gap symbol of the pattern of time resources, or both.

Aspect 9: The method of any of aspects 1 through 8, wherein a first symbol of the pattern of time resources is an automatic gain control symbol that is a repetition of a second symbol of the pattern of time resources.

Aspect 10: The method of any of aspects 1 through 9, wherein the pattern of time resources is indicated in one or more slots, one or more mini-slots, or both.

Aspect 11: A method for wireless communication at a first UE, comprising: performing a sensing operation to determine available resources for sidelink communication with the first UE; transmitting sidelink control information that indicates a pattern of time resources of the available resources in which the first UE is to transmit sidelink signaling, wherein the pattern of time resources spans multiple slots; and transmitting one or more sidelink messages to a second UE in accordance with the pattern of time resources.

Aspect 12: The method of aspect 11, wherein the sidelink control information is transmitted in one or more first symbols of the pattern of time resources, wherein the sidelink control information is a lone sidelink control information of the pattern of time resources.

Aspect 13: The method of any of aspects 11 through 12, further comprising: receiving a plurality of start and length indicator value patterns, wherein the pattern of time resources comprises one of the plurality of start and length indicator value patterns.

Aspect 14: The method of any of aspects 11 through 13, further comprising: receiving a resource pool indication that indicates a quantity of the multiple slots that are spanned by the pattern of time resources.

Aspect 15: The method of any of aspects 11 through 14, wherein the pattern of time resources indicates a gap symbol that is a last symbol and an only gap symbol of the pattern of time resources, or both.

Aspect 16: The method of any of aspects 11 through 15, further comprising: transmitting, in at least first symbol of a slot of the multiple slots other than a first slot of the multiple slots, a data transmission comprising a sidelink control information presence indication comprising one or more punctured resource elements, one or more punctured resource blocks, second sidelink control information of a format different than a format of the sidelink control information, one or more reference signals on one or more tones in the slot, or any combination thereof.

Aspect 17: The method of aspect 16, further comprising: transmitting an indication that that the sidelink control information presence indication will be included in the data transmission.

Aspect 18: A method for wireless communication at a second UE, comprising: receiving an indication of a resource pool of resources available for sidelink communication with the second UE; receiving, from a network entity, an indication of a sidelink communication configuration that is associated with a pattern of time resources of the resource pool in which the second UE is to receive sidelink signaling, the pattern of time resources spanning multiple slots; and receiving one or more sidelink messages from a first UE in accordance with the pattern of time resources.

Aspect 19: The method of aspect 18, further comprising: receiving sidelink control information comprising an indication of the pattern of time resources across the multiple slots and one or more indications of a device with which the first UE is to communicate in each time resource of the pattern of time resources.

Aspect 20: The method of aspect 19, wherein the sidelink control information is received in one or more first symbols of the pattern of time resources and is not repeated in the pattern of time resources.

Aspect 21: The method of any of aspects 18 through 20, wherein the pattern of time resources indicates a plurality of start and length indicator values.

Aspect 22: The method of any of aspects 18 through 21, wherein the sidelink communication configuration indicates a selection of a start and length indicator value pattern of a plurality of start and length indicator value patterns.

Aspect 23: The method of any of aspects 18 through 22, wherein the indication of the resource pool indicates a quantity of the multiple slots that are spanned by the pattern of time resources.

Aspect 24: The method of any of aspects 18 through 23, wherein the indication of the sidelink communication configuration is received via radio resource control signaling or downlink control information.

Aspect 25: The method of any of aspects 18 through 24, wherein the pattern of time resources indicates a gap symbol that is a last symbol and an only gap symbol of the pattern of time resources, or both.

Aspect 26: The method of any of aspects 18 through 25, wherein a first symbol of the pattern of time resources is an automatic gain control symbol that is a repetition of a second symbol of the pattern of time resources.

Aspect 27: The method of any of aspects 18 through 26, wherein the pattern of time resources is indicated in one or more slots, one or more mini-slots, or both.

Aspect 28: A method for wireless communication at a first UE, comprising: receiving sidelink control information that indicates a pattern of time resources of the available resources in which the second UE is to receive sidelink signaling, wherein the pattern of time resources spans multiple slots; and receiving one or more sidelink messages from a first UE in accordance with the pattern of time resources.

Aspect 29: The method of aspect 28, wherein the sidelink control information is received in one or more first symbols of the pattern of time resources, wherein the sidelink control information is a lone sidelink control information of the pattern of time resources.

Aspect 30: The method of any of aspects 28 through 29, further comprising: receiving a plurality of start and length indicator value patterns, wherein the pattern of time resources comprises one of the plurality of start and length indicator value patterns.

Aspect 31: The method of any of aspects 28 through 30, further comprising: receiving a resource pool indication that indicates a quantity of the multiple slots that are spanned by the pattern of time resources.

Aspect 32: The method of any of aspects 28 through 31, wherein the pattern of time resources indicates a gap symbol that is a last symbol and an only gap symbol of the pattern of time resources, or both.

Aspect 33: The method of any of aspects 28 through 32, further comprising: receiving, in at least first symbol of a slot of the multiple slots other than a first slot of the multiple slots, a data transmission comprising a sidelink control information presence indication comprising one or more punctured resource elements, one or more punctured resource blocks, second sidelink control information of a format different than a format of the sidelink control information, one or more reference signals on one or more tones in the slot, or any combination thereof.

Aspect 34: The method of aspect 33, further comprising: receiving an indication that that the sidelink control information presence indication will be included in the data transmission.

Aspect 35: An apparatus comprising one or more processors; memory coupled with the one or more processors; and instructions stored in the memory and executable by the one or more processors to cause the apparatus to perform a method of any of aspects 1 through 10.

Aspect 36: An apparatus comprising at least one means for performing a method of any of aspects 1 through 10.

Aspect 37: A non-transitory computer-readable medium storing code the code comprising instructions executable by a processor to perform a method of any of aspects 1 through 10.

Aspect 38: An apparatus comprising one or more processors; memory coupled with the one or more processors; and instructions stored in the memory and executable by the one or more processors to cause the apparatus to a method of any of aspects 11 through 17.

Aspect 39: An apparatus comprising at least one means for performing a method of any of aspects 11 through 17.

Aspect 40: A non-transitory computer-readable medium storing code the code comprising instructions executable by a processor to perform a method of any of aspects 11 through 17.

Aspect 41: An apparatus for wireless communication at a second UE, comprising one or more processors; memory coupled with the one or more processors; and instructions stored in the memory and executable by the one or more processors to cause the apparatus to a method of any of aspects 18 through 27.

Aspect 42: An apparatus for wireless communication at a second UE, comprising at least one means for performing a method of any of aspects 18 through 27.

Aspect 43: A non-transitory computer-readable medium storing code for wireless communication at a second UE, the code comprising instructions executable by a processor to perform a method of any of aspects 18 through 27.

Aspect 44: An apparatus comprising one or more processors; memory coupled with the one or more processors; and instructions stored in the memory and executable by the one or more processors to cause the apparatus to a method of any of aspects 28 through 34.

Aspect 45: An apparatus comprising at least one means for performing a method of any of aspects 28 through 34.

Aspect 46: A non-transitory computer-readable medium storing code the code comprising instructions executable by a processor to perform a method of any of aspects 28 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
at least one processor; and
memory coupled with the at least one processor, the memory storing instructions for the at least one processor to cause the first UE to:
receive an indication of a resource pool of resources available for sidelink communication with the first UE;
receive, from a network entity, an indication of a sidelink communication configuration that is associated with a pattern of time resources of the resource pool in which the first UE is to transmit sidelink signaling, the pattern of time resources spanning multiple slots; and
transmit one or more sidelink messages to a second UE in accordance with the pattern of time resources.

2. The first UE of claim 1, wherein the instructions are further for the at least one processor to cause the first UE to:
transmit sidelink control information comprising an indication of the pattern of time resources across the multiple slots and one or more indications of a device with which the first UE is to communicate in each time resource of the pattern of time resources.

3. The first UE of claim 2, wherein:
the sidelink control information is transmitted in one or more first symbols of the pattern of time resources and is not repeated in the pattern of time resources.

4. The first UE of claim 1, wherein:
the pattern of time resources indicates a plurality of start and length indicator values.

5. The first UE of claim 1, wherein:
the sidelink communication configuration indicates a selection of a start and length indicator value pattern of a plurality of start and length indicator value patterns.

6. The first UE of claim 1, wherein:
the indication of the resource pool indicates a quantity of the multiple slots that are spanned by the pattern of time resources.

7. The first UE of claim 1, wherein:
the indication of the sidelink communication configuration is received via radio resource control signaling or downlink control information.

8. The first UE of claim 1, wherein:
the pattern of time resources indicates a gap symbol that is a last symbol and an only gap symbol of the pattern of time resources, or both.

9. The first UE of claim 1, wherein:
a first symbol of the pattern of time resources is an automatic gain control symbol that is a repetition of a second symbol of the pattern of time resources.

10. The first UE of claim 1, wherein:
the pattern of time resources is indicated in one or more slots, one or more mini-slots, or both.

11. A first user equipment (UE), comprising:
at least one processor; and
memory coupled with the at least one processor, the memory storing instructions for the at least one processor to cause the first UE to:
perform a sensing operation to determine available resources for sidelink communication with the first UE;
transmit sidelink control information that indicates a pattern of time resources of the available resources in which the first UE is to transmit sidelink signaling, wherein the pattern of time resources spans multiple slots; and transmit one or more sidelink messages to a second UE in accordance with the pattern of time resources.

12. The first UE of claim 11, wherein:
the sidelink control information is transmitted in one or more first symbols of the pattern of time resources; and
the sidelink control information is a lone sidelink control information of the pattern of time resources.

13. The first UE of claim 11, wherein the instructions are further for the at least one processor to cause the first UE to:
receive a plurality of start and length indicator value patterns, wherein the pattern of time resources comprises one of the plurality of start and length indicator value patterns.

14. The first UE of claim 11, wherein the instructions are further for the at least one processor to cause the first UE to:
receive a resource pool indication that indicates a quantity of the multiple slots that are spanned by the pattern of time resources.

15. The first UE of claim 11, wherein:
the pattern of time resources indicates a gap symbol that is a last symbol and an only gap symbol of the pattern of time resources, or both.

16. The first UE of claim 11, wherein the instructions are further for the at least one processor to cause the first UE to:
transmit, in at least first symbol of a slot of the multiple slots other than a first slot of the multiple slots, a data transmission comprising a sidelink control information presence indication comprising one or more punctured resource elements, one or more punctured resource blocks, second sidelink control information of a format different than a format of the sidelink control information, one or more reference signals on one or more tones in the slot, or any combination thereof.

17. The first UE of claim 16, wherein the instructions are further for the at least one processor to cause the first UE to:
transmit an indication that that the sidelink control information presence indication will be included in the data transmission.

18. A second user equipment (UE), comprising:
at least one processor; and
memory coupled with the at least one processor, the memory storing instructions for the at least one processor to cause the second UE to:
receive an indication of a resource pool of resources available for sidelink communication with the second UE;
receive, from a network entity, an indication of a sidelink communication configuration that is associated with a pattern of time resources of the resource pool in which the second UE is to receive sidelink signaling, the pattern of time resources spanning multiple slots; and
receive one or more sidelink messages from a first UE in accordance with the pattern of time resources.

19. The second UE of claim 18, wherein the instructions are further for the at least one processor to cause the second UE to:
receive sidelink control information comprising an indication of the pattern of time resources across the multiple slots and one or more indications of a device with which the first UE is to communicate in each time resource of the pattern of time resources.

20. The second UE of claim 19, wherein:
the sidelink control information is received in one or more first symbols of the pattern of time resources and is not repeated in the pattern of time resources.

21. The second UE of claim 18, wherein:
the pattern of time resources indicates a plurality of start and length indicator values.

22. The second UE of claim 18, wherein:
the sidelink communication configuration indicates a selection of a start and length indicator value pattern of a plurality of start and length indicator value patterns.

23. The second UE of claim 18, wherein:
the indication of the resource pool indicates a quantity of the multiple slots that are spanned by the pattern of time resources.

24. The second UE of claim 18, wherein:
the pattern of time resources indicates a gap symbol that is a last symbol and an only gap symbol of the pattern of time resources, or both.

25. A second user equipment (UE), comprising:
at least one processor; and
memory coupled with the at least one processor, the memory storing instructions for the at least one processor to cause the second UE to:
receive sidelink control information that indicates a pattern of time resources in which the second UE is to receive sidelink signaling, wherein the pattern of time resources spans multiple slots; and
receive one or more sidelink messages from a first UE in accordance with the pattern of time resources.

26. The second UE of claim 25, wherein:
the sidelink control information is received in one or more first symbols of the pattern of time resources; and
the sidelink control information is a lone sidelink control information of the pattern of time resources.

27. The second UE of claim 25, wherein the instructions are further for the at least one processor to cause the second UE to:
receive a plurality of start and length indicator value patterns, wherein the pattern of time resources comprises one of the plurality of start and length indicator value patterns.

28. The second UE of claim 25, wherein the instructions are further for the at least one processor to cause the second UE to:
receive a resource pool indication that indicates a quantity of the multiple slots that are spanned by the pattern of time resources.

29. The second UE of claim 25, wherein the instructions are further for the at least one processor to cause the second UE to:
receive, in at least first symbol of a slot of the multiple slots other than a first slot of the multiple slots, a data transmission comprising a sidelink control information presence indication comprising one or more punctured resource elements, one or more punctured resource blocks, second sidelink control information of a format different than a format of the sidelink control information, one or more reference signals on one or more tones in the slot, or any combination thereof.

30. The second UE of claim 29, wherein the instructions are further for the at least one processor to cause the second UE to:
receive an indication that that the sidelink control information presence indication will be included in the data transmission.
